(19) United States
(12) Patent Application Publication
(10) Pub. No.: US 2005/0030746 A1
(43) Pub. Date: Feb. 10, 2005

(54) Skateboard light

(76) Inventors: Bradley A. Goode, Beverly Hills, CA (US); Wayne Carmona, Los Angeles, CA (US)

Correspondence Address: COUDERT BROTHERS LLP, 333 SOUTH HOPE STREET, 23RD FLOOR, LOS ANGELES, CA, 90071, US

(21) Appl. No.: 10/863,607

(22) Filed: Jun. 7, 2004

Related U.S. Application Data
(60) Provisional application No. 60/476,869, filed on Jun. 6, 2003.

(51) Int. Cl. F21V 33/00

(52) U.S. Cl. 362/253

(57) ABSTRACT

The invention is an apparatus and method for attaching a pair of light assemblies to a skateboard. The assemblies are attached by removing the bolts that attach the trucks to the deck, aligning each assembly with a truck, and re-attaching the bolts so that there is a truck in between the deck and light assembly. The assemblies have a lid that can be opened to expose a chamber housing a battery to power the light generative apparatus (e.g. LEDs or light bulbs or equivalents) at the end of each assembly. To turn on or off the lights, a user alternately taps on the lid of each assembly or uses a switch in each assembly. Alternatively, the front and back assemblies are connected by a flat horizontal structure that has a sensor for receiving tapping pressure to turn on or off the lights.

### PRIORITY CLAIM

This application claims priority to U.S. Provisional Patent Application No. 60/476,869 filed Jun. 6, 2003.

### BACKGROUND OF THE INVENTION

1. Field of the Invention

The present invention relates to skateboards, and in particular to an apparatus and method of attaching a pair of light assemblies to a skateboard.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

A skateboard is usually comprised of three main elements: the board or deck, the wheels, and the trucks which connect the wheels to the board and allow the board to turn. One reason why contemporary skateboards are such perfectly balanced means for transportation, and yet sturdy and maintenance free is because they are made from maple veneers which are known to have a combination of toughness, elasticity feel and response better than epoxy, fiberglass, or carbon loaded thermoplastic nylon, which are some of the other materials considered when manufacturing a good quality skateboard. Traditionally, it takes 7 plies of sugar maple veneers to be pressed together under high pressure (usually around 300 psi) using a polyvinyl glue in an aluminum, metal, or concrete mold to form the board. After about an hour, the board is removed from the mold and left to cure for several more days. At this stage, the board is not just a flat piece, but has concave curves at the nose (front end of the skateboard) and tail (back end of the skateboard), which vary in degree and angle from one manufacturer to the next. A router is then used to cut the board to its final shape, which ranges from 20 to 44 inches in length and 7.5 to 8 inches in width. An edge trimming is applied to the rail, and the board is painted or lacquered to its finished look. Grip tape made of sandpaper may be affixed to the top of the deck with adhesive to increase the friction between the deck and the skater's feet.

The trucks, which are front and back axle assemblies that connect the wheels to the board and provide the turning capabilities of the board, are fixed to the underside of the deck. These trucks range in sizes from 5″ to 8.5″ in length depending on the manufacturer and size of the deck. Each manufacturer also has its own wheelbase, which is the distance between the front and back wheels measured between the two sets of innermost truck holes. The 4 wheels, usually made of polyurethane and ranging in size from 39 to 66 millimeters in diameter are attached to the trucks (2 for the front truck and 2 for the back). A good contemporary skateboard has a plan form, which is the shape of the board's outline by placing the board flat up against a wall and tracing out its outline on the wall, suitable for perfectly balanced maneuver and for other recreational uses.

Since a contemporary skateboard is such a simple device, it is also a favorite means for transportation for people who want to travel a short distance or who want to quickly travel “pedestrian traffic only” areas. While people who travel on skateboards can attain high speeds, there is a high risk of accidents at night because skateboards usually do not have any lights or reflectors to warn automobile drivers of their presence. Risk of accidents is further augmented if the skateboard rider wears non-reflective or dark clothing. Therefore, a need is being felt to make skateboards safer to use at night, or in adverse weather conditions.

### SUMMARY OF THE INVENTION

The embodiments of the present invention provide an apparatus and a method for attaching a pair of light assemblies to a skateboard. According to one embodiment of the present invention, the assemblies, which are U-shaped are attached to the underside of the deck. According to another embodiment of the present invention, the U-shaped assemblies are attached to the underside of the deck by first removing the bolts that attach the supplied trucks to the deck, aligning the bolt holes of each assembly over the bolt holes of each truck, and re-attaching the supplied bolts so that there is a truck in between the deck and each light assembly. According to another embodiment of the present invention, there is a light generating apparatus (e.g. light bulb, LED (Light Emitting Diode) or any other lighting equivalent) at each end of the U-shaped assemblies. According to another embodiment of the present invention, the U-shaped assemblies have a lid each that can be opened to expose a chamber that houses a battery needed to power the light generating apparatus (e.g. bulbs or LEDs). According to another embodiment of the present invention, the front light assembly (the light assembly attached to the front end of the board via the front truck) has white light generating apparatus (e.g. light LEDs or light bulbs) to mimic the headlights of a car, and the back light assembly (the light assembly attached to the back end of the board via the back truck) has red light generating apparatus (e.g. LEDs or light bulbs) to mimic the taillights of a car.

Several switching mechanisms are available in various embodiments. According to one embodiment of the present invention, in order to turn on all the lights (there are 4 lights, 2 in the front assembly and 2 in the back), a user taps on the lid of each assembly a first time to activate an integrated switch that allows the flow of power from the battery to the light generating apparatus such as LEDs or light bulbs. According to another embodiment of the present invention, in order to turn off all the lights, the user taps on each lid a second time to deactivate the integrated switches.

In accordance to another embodiment, each assembly has a switch for turning off and on the light. According to another embodiment of the present invention, the front and back light assemblies are connected by a flat horizontal structure that also houses an integrated switch. According to another embodiment of the present invention, in order to turn on all the lights the user taps on the flat horizontal structure connecting the front and back assemblies a first time to activate the integrated switch that allows the flow of power from each battery (housed within each of the light assemblies) to its respective light generating apparatus (e.g. light bulbs or LEDs). According to another embodiment of the present invention, in order to turn off all the lights, the user taps on the flat horizontal structure a second time to deactivate the integrated switch. According to another embodiment of the present invention, the flat horizontal structure is a printed circuit board controlled by a remote control that turns the power on and off to the light generating apparatus via the batteries.

According to another embodiment of the present invention, the light assemblies may be attached to not only the under-carriage of skateboards, but also to the under-carriage of roller blades and baby strollers/carriages, and to the top of snowboards.

### BRIEF DESCRIPTION OF THE DRAWINGS

These and other features, aspects and advantages of the present invention will become better understood with regard to the following description, appended claims and accompanying drawings where:

FIG. 1 illustrates plan views showing the dimensions of a light assembly, according to the present invention.

FIG. 2 is a flowchart illustrating the assembling of the light assembly onto a skateboard.

FIG. 3 is a perspective view of a light assembly, according to an embodiment of the present invention.

FIG. 4 is a perspective view of a light assembly, according to another embodiment of the present invention.

FIG. 5 is a perspective view of a light assembly, according to another embodiment of the present invention.

FIG. 6 is a perspective view of a light assembly, according to another embodiment of the present invention.

FIG. 7 is a perspective view of a light assembly, according to another embodiment of the present invention.

FIG. 8 is a perspective view of a light assembly, according to another

### DETAILED DESCRIPTION OF THE INVENTION

The embodiments of the present invention are an apparatus and a method of attaching a pair of light assemblies to a skateboard. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

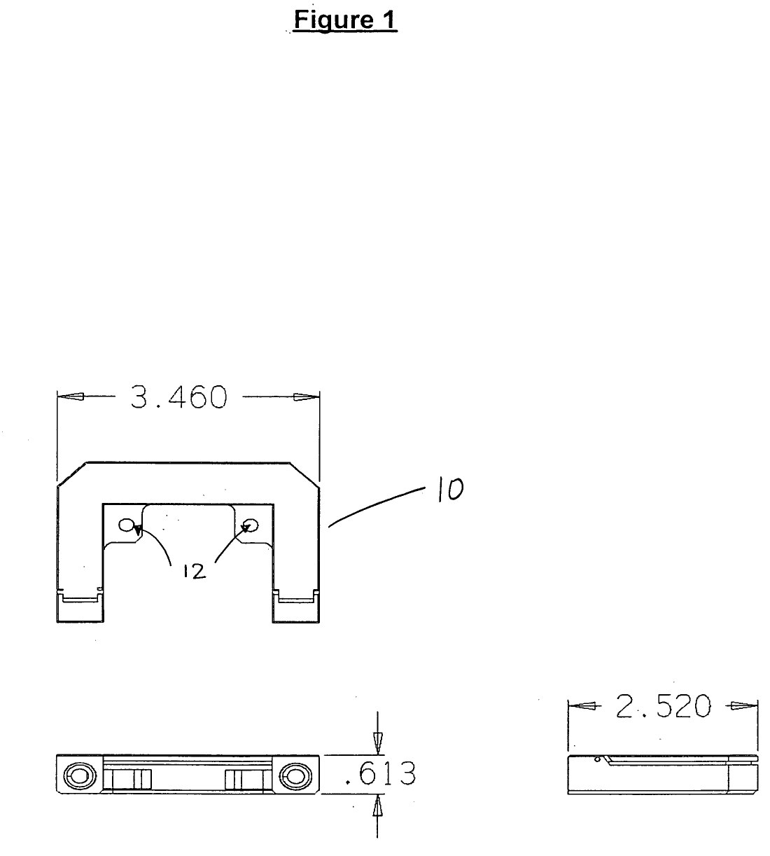

According to one embodiment of the present invention, light assembly 10 is a U-shaped structure made of plastic or metal, with a pair of bolt holes 12 adapted for installing the light assembly to the under carriage of the skateboard. FIG. 1 illustrates plan views of one embodiment of a light assembly with its width (3.460 inches), thickness (0.613 inches), and depth (2.520 inches) dimensions. It should be noted however that the dimensions mentioned in FIG. 1 are for purposes of illustration only, and other dimensions are equally possible.

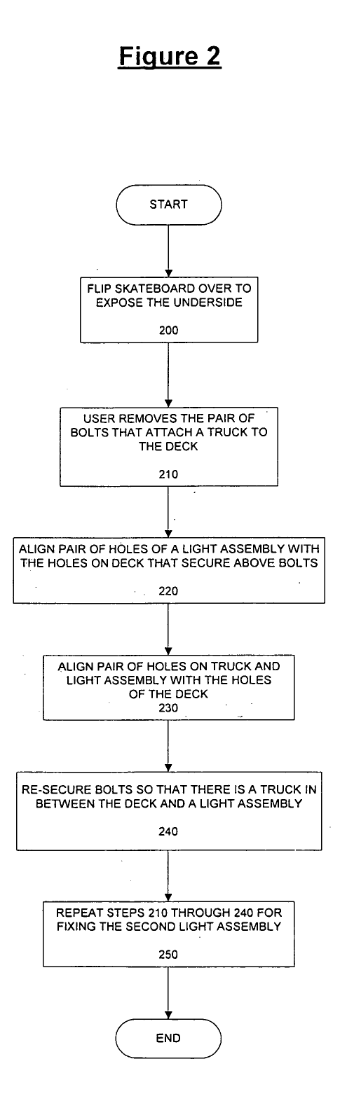

According to another embodiment of the present invention, a pair light assemblies, one in the front and one in the back, are attached to the underside of a skateboard. According to another embodiment of the present invention, in order to attach the light assemblies, a user has to first remove the existing bolts that attach the pair of trucks to the underside of the deck. Next, a light assembly is placed over a truck so that the bolt holes on the assembly and the truck align. Finally, the bolts are re-attached so that there is a truck in between each light assembly and the deck. FIG. 2 is a flowchart illustrating the attachment of the light assemblies to the deck as explained above. At step 200, the skateboard is flipped over so that the underside of the board is exposed to a user. At step 210, the user removes the 2 bolts that attach a truck to the board. At step 220, a pair of holes on a light assembly are aligned to match the holes on the truck that secure the bolts. At step 230, the pair of holes on the truck and assembly are aligned to match the pair of holes in the deck that accept the bolts. At step 240, the bolts are re-secured back to the deck so that there is a truck sandwiched in between a light assembly and the deck. At step 250, steps 210 through 240 are repeated in order to sandwich the other truck in between the another light assembly and the deck.

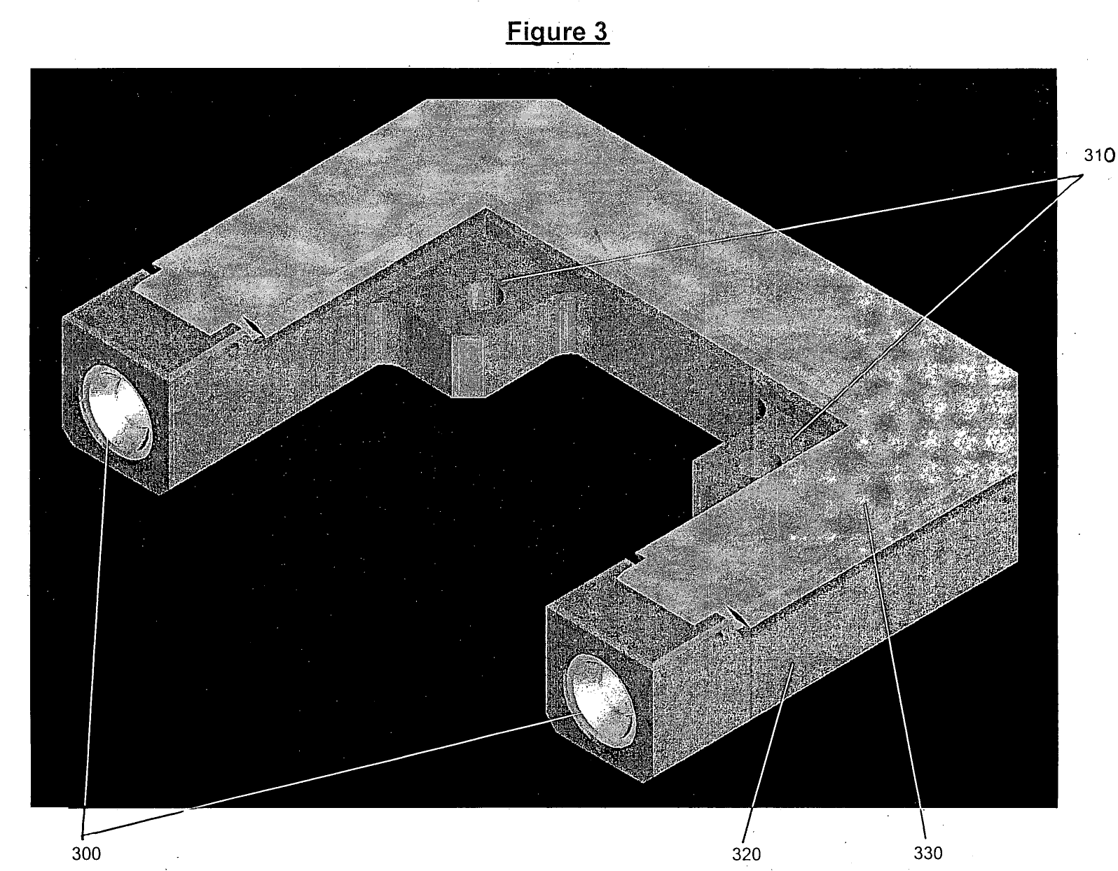

FIG. 3 illustrates a top 3-dimensional view of a light assembly with a closed lid. As one can see, light assembly 320 is U-shaped with light generating apparatus 300 (e.g LEDs or bulbs) at each end. According to one embodiment of the present invention, the bulbs are white light generating apparatus (e.g. LEDs or light bulbs) to mimic the headlights of a car. According to another embodiment of the present invention, the bulbs are red light generating apparatus (e.g. LEDs or light bulbs) to mimic the taillights of a car. 310 are the holes that are aligned with the holes of the truck and deck as explained above so that a truck can be sandwiched in between a light assembly and the deck. The light assembly has a lid 330 that can be opened to expose a battery compartment that houses a battery to power the light generating apparatus. In operation, once the light assembly is attached and the skateboard is turned so that it is ready to use, the lid of the light assembly faces the road. In other words, once the assembly is attached, the lid can be accessed by a user.

Lid in the Light Assembly

The lid is adapted to receive tapping pressure from the user. Thus the user would be to tap on it to activate or deactivate an integrated switch within the battery compartment. A first tap activates the switch turning the light generating apparatus (e.g. LEDs or light bulbs) on. A second tap deactivates the switch turning the light generating apparatus off. In this configuration, in order to turn on or off all the lights (a pair of lights in the front assembly and a pair of lights in the rear assembly), a user has to tap the lid of each assembly. This means that the user has to tap twice, one each for both the front and rear assemblies to turn on all four lights, and twice again to turn off all 4 lights.

According to one embodiment of the present invention, the front and rear light assemblies connected to the front and rear trucks respectively are joined together via a flat structure resembling a ruler. According to another embodiment of the present invention, this flat structure is made of plastic or metal and has the integrated switch built into it. In this embodiment, in order to turn on all the lights, a user taps on the flat structure connecting the two assemblies activating the switch that powers the battery packs in each assembly. In this configuration, a user taps just once to turn on all four lights and once again to shut them all down, unlike the previous configuration where two taps are needed to either turn on and turn off all four lights. Since the switch activates the front and back battery packs independent of each other, the front and back light generating apparatus work independent of each other. In other words, if a bulb in the front or back assembly is broken or non-functional, it does not affect the other light generating apparatus from turning on or off.

In accordance to another embodiment, a simple switch is placed in the assembly so that the user can switch the light on and off in the assembly.

According to another embodiment of the present invention, the flat structure joining the front and rear light assemblies is a printed circuit board controlled by a remote control. In this embodiment the 4 lights are turned on and off remotely by pressing a button on an external remote control that can be placed in the pocket of the user. In this embodiment the user does not have to turn the skateboard upside down to activate the light generating apparatus (e.g. light bulbs or LEDs) as in the previous two embodiments where the user had to either tap the light assemblies individually or tap the flat structure in order to turn on or off the lights. If the user is using the skateboard, then the user has to press a button on the remote to turn on or off the lights. On the other hand, if the user is at a distance from the skateboard and wants to turn on or off the lights, then the user has to aim the remote control in the general direction of the skateboard in order to activate the circuit board to turn on or off the power from the batteries that power the individual light assemblies.

Another reason to access the lid would be to change the battery when its power runs out, to replace a faulty or broken integrated switch, or to change a faulty or burnt bulb.

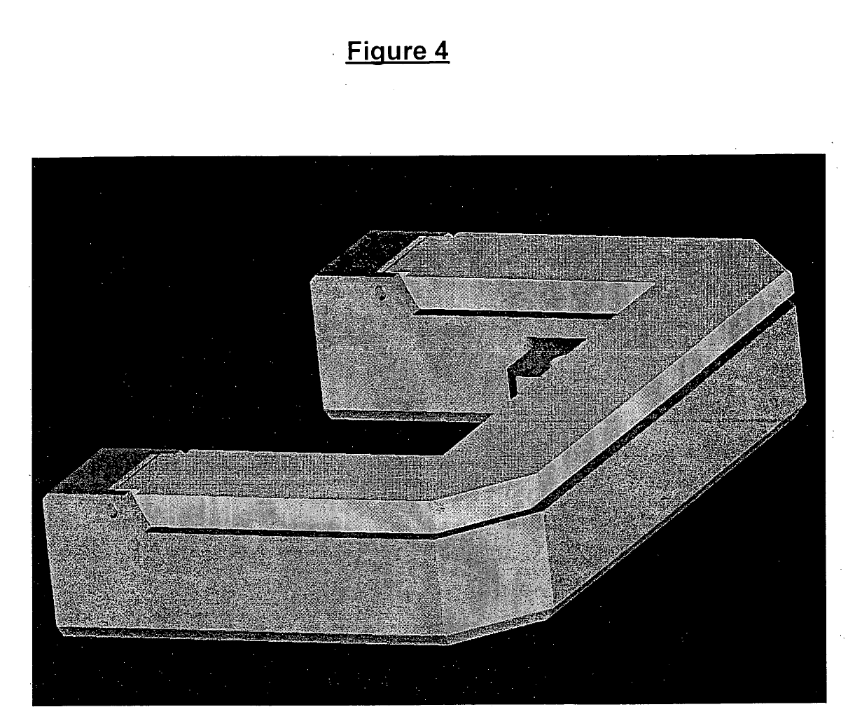

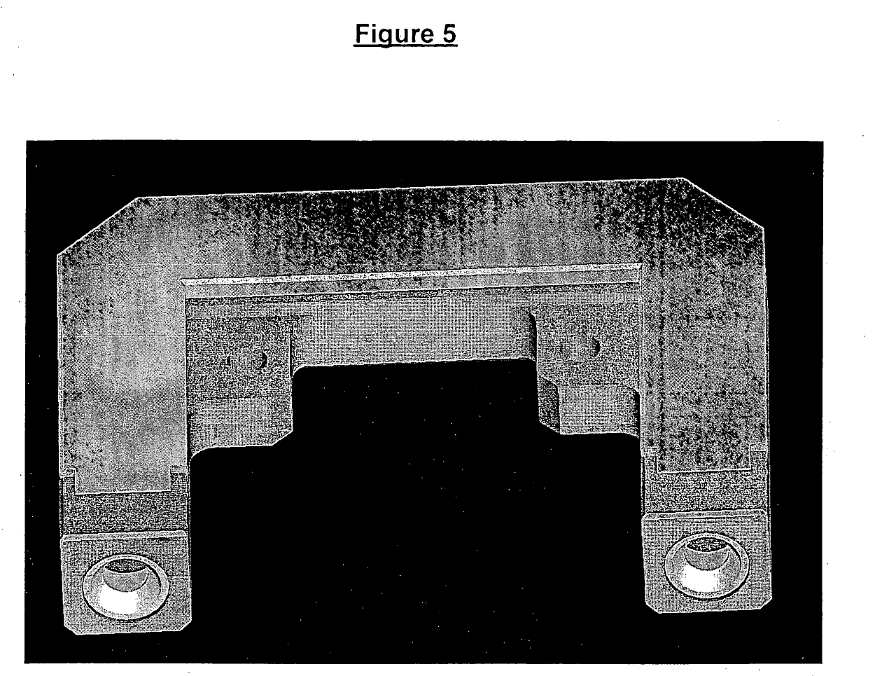

FIG. 4 is another 3-dimensional view of a light assembly with the lid closed giving a viewer a top view of the assembly. FIG. 5 is yet another view of the light assembly giving the viewer a top view of the assembly from another angle.

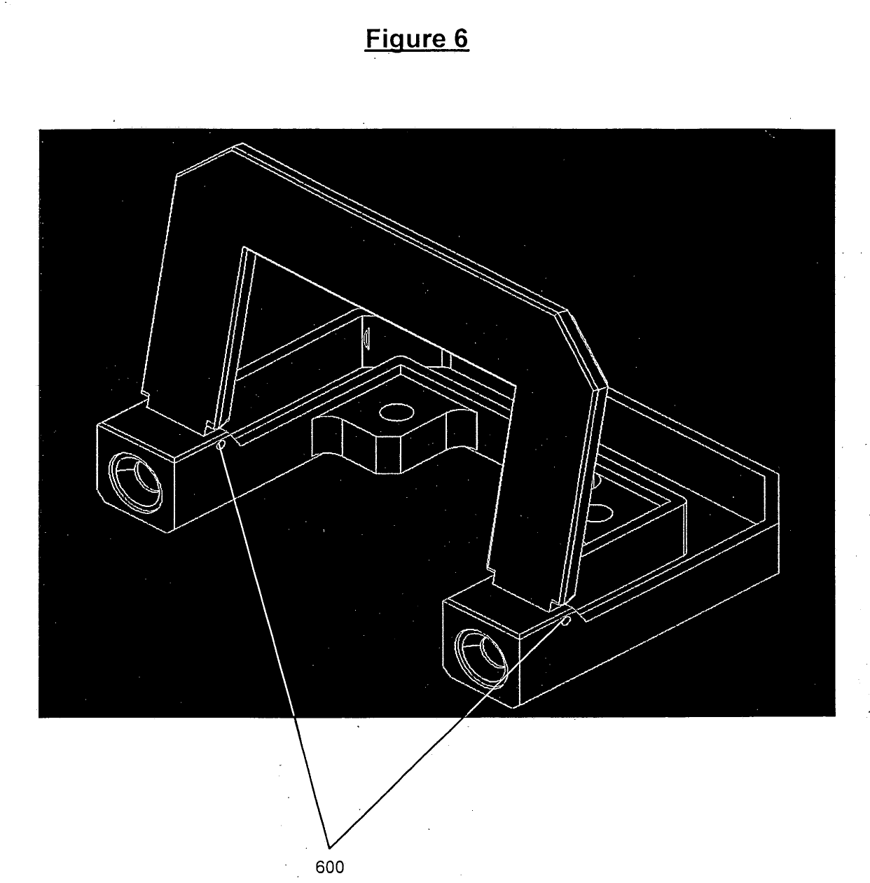

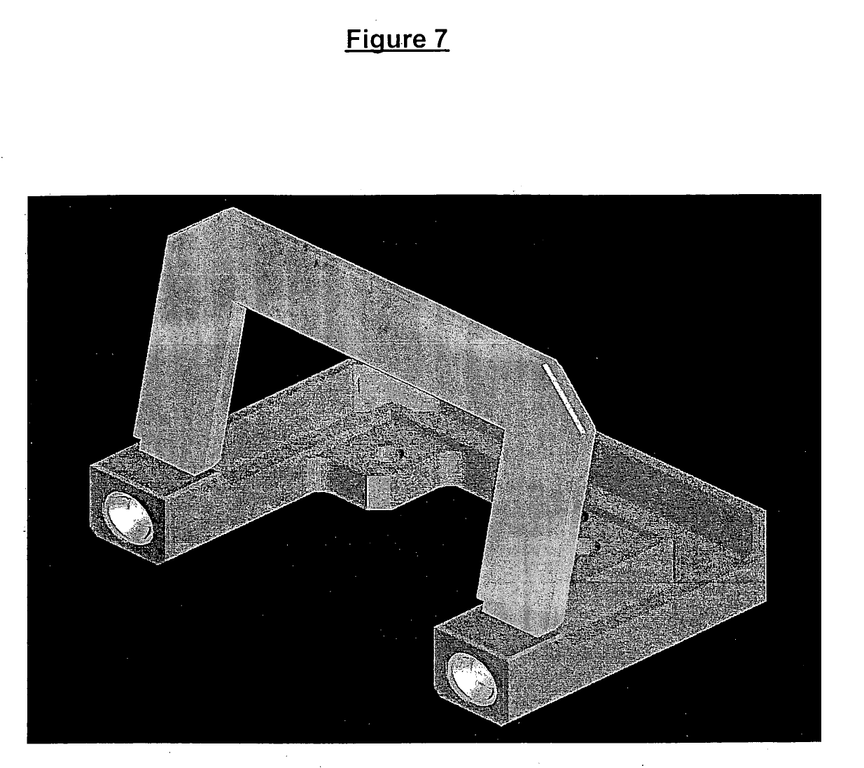

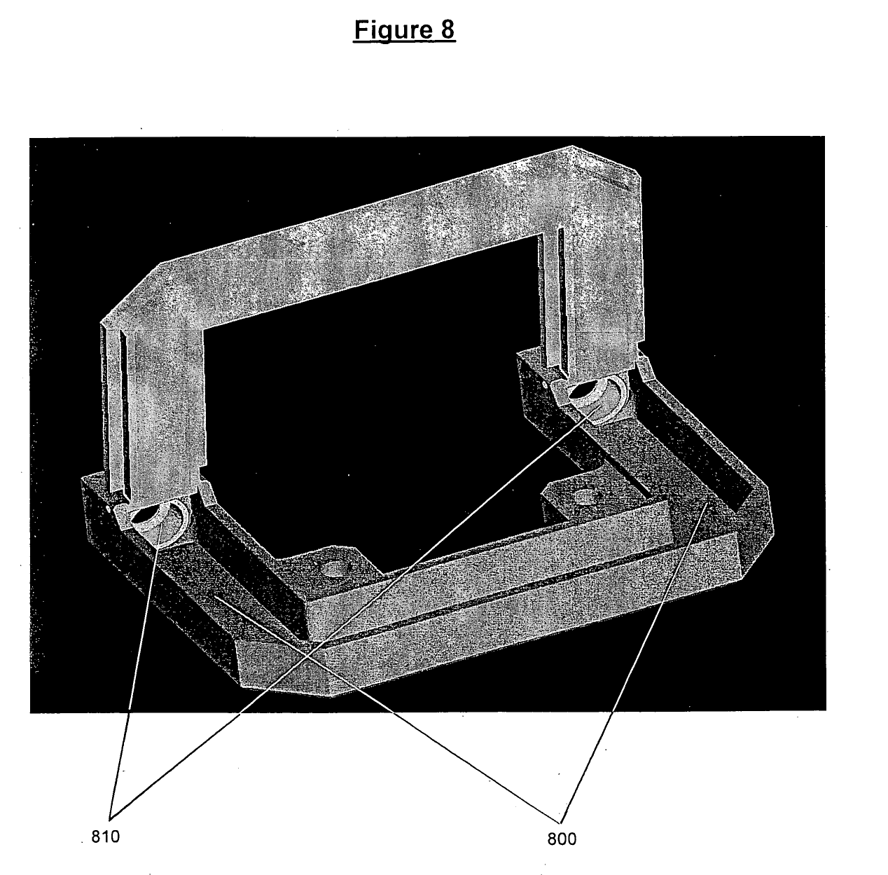

FIG. 6 is a 3-dimennsional view of a light assembly with its lid in the open position. According to one embodiment of the present invention, there are hinges (item 600 in FIG. 6) that pivot the lid open and shut. According to another embodiment of the present invention, the lid has snaps that lock the lid shut over the light assembly in the closed position (not shown). The lid can be removed off the light assembly by pulling on the snaps much like removing a plastic lid off a jar. FIG. 7 is another view of the light assembly with the lid in the open position. FIG. 8 is yet another view of the light assembly from a different angle. This view shows the battery compartment (item 800), and the openings (item 810) on either side of the assembly to house the light generating apparatus (LEDs or bulbs).

According to another embodiment of the present invention, the light assemblies are attached to the under-carriage of roller blades and baby strollers/carriages. In this embodiment, the light assemblies can be turned on or off using any of the three mechanisms explained above, viz., tapping individually on the front and rear light assemblies, tapping a horizontal structure connecting the front and rear light assemblies, or using a remote control to turn on or off the 4 lights.

According to another embodiment of the present invention, the light assemblies are attached to the top of a snow board. In this embodiment, since there are no trucks to attach the light assemblies to, the light assemblies may be attached to the top of the snowboard at the front and rear ends with a Velcro® or adhesive tape. In this embodiment, since the user is on the same side as the light assemblies, the lights can be turned on or off using the remote control mechanism explained above. In other words, the front and rear light assemblies are connected by a circuit board which can be embedded a millimeter into the top of the snowboard and controlled externally by a remote control.

Thus, an apparatus and a method for attaching a pair of light assemblies to a skateboard is described in conjunction with one or more specific embodiments. The present invention is defined by the claims and their full scope of equivalents.

1. A skateboard lighting assembly comprising:
a front lighting assembly adapted to be attached to the under-carriage of a skateboard;
a back lighting assembly adapted to be attached to the under-carriage of said skateboard.

2. The skateboard lighting assembly of claim 1 wherein said front lighting assembly further comprises:
a lid adapted to respond to external tapping pressure to control lighting operation of said front lighting assembly;
a housing covered by said lid.

3. The skateboard light assembly of claim 2 wherein said housing further comprises:
an integrated switch;
a battery compartment; and
a pair of light generating apparatus.

4. The skateboard light assembly of claim 3 wherein said light generating apparatus are white LEDs.

5. The skateboard light assembly of claim 3 wherein said light generating apparatus are white light bulbs.

6. The skateboard light assembly of claim 2 wherein said lid is attached to said housing by a hinge to allow said lid to be flipped open and close.

7. The skateboard lighting assembly of claim 1 wherein said front lighting assembly is a U-shaped assembly.

8. The skateboard lighting assembly of claim 1 wherein said back lighting assembly further comprises:
a lid adapted to respond to external tapping pressure to control lighting operation of said front lighting assembly;
a housing covered by said lid.

9. The skateboard light assembly of claim 8 wherein said housing further comprises:
an integrated switch;
a battery compartment; and
a pair of light generating apparatus.

10. The skateboard light assembly of claim 9 wherein said light generating apparatus are red LEDs.

11. The skateboard light assembly of claim 9 wherein said light generating apparatus are red light bulbs.

12. The skateboard light assembly of claim 8 wherein said lid is attached to said housing by a hinge to allow said lid to be flipped open and close.

13. The skateboard lighting assembly of claim 1 wherein said back lighting assembly is a U-shaped assembly.

14. A skateboard lighting assembly comprising:
a front lighting assembly adapted to be attached to the under-carriage of a skateboard;
a back lighting assembly adapted to be attached to the under-carriage of said skateboard; and
a circuit connection connecting said front lighting assembly and said back lighting assembly.

15. The skateboard light assembly of claim 14 wherein said circuit connection further comprises:
a receiver configured to receive signals from a remove control to control operation of said front lighting assembly and said back lighting assembly.

16. A light assembly for a moving device comprising:
a lid adapted to respond to external tapping pressure to control lighting operation of said front lighting assembly;
a housing covered by said lid, wherein said housing further comprises:
an integrated switch;
a battery compartment; and
a pair of light generating apparatus.

17. The light assembly of claim 15 wherein said lid is attached to said housing by a hinge to allow said lid to be flipped open and close.

18. The light assembly of claim 15 wherein said back lighting assembly is a U-shaped assembly.

19. A skateboard lighting assembly adapted to be attached to the under-carriage of a skateboard comprising:
a lid;
a housing covered by said lid, wherein said housing further comprises:
a battery compartment; and
a pair of light generating apparatus.
an switch to control the operation of said light generating apparatus.

20. A method of affixing a light assembly to a skateboard, comprising:
removing bolts that attach a pair of trucks to a deck of a skateboard;
removing said pair of trucks from said deck;
inserting a first light assembly into a position beneath the first of said pair of trucks and said deck, whereby said first truck is between said deck and said first light assembly;
aligning bolt holes of said first light assembly with bolt holes of said first truck;
inserting bolts into through said first light assembly and said first truck to affix said first light assembly to said deck;
inserting a second light assembly into a position beneath the second of said pair of trucks and said deck, whereby said second truck is between said deck and said second light assembly;
aligning bolt holes of said second light assembly with bolt holes of said second truck;
inserting bolts into through said second light assembly and said second truck to affix said second light assembly to said deck.

21. The method of claim 20 wherein said first light assembly comprises:
a lid adapted to respond to external tapping pressure to control lighting operation of said first lighting assembly;
a housing covered by said lid, wherein said housing further comprises:
an integrated switch;
a battery compartment; and
a pair of light generating apparatus.

22. The method of claim 20 wherein said second light assembly comprises:
a lid adapted to respond to external tapping pressure to control lighting operation of said second lighting assembly;
a housing covered by said lid, wherein said housing further comprises:
an integrated switch;
a battery compartment; and
a pair of light generating apparatus.
